(19) United States
(12) Patent Application Publication
(10) Pub. No.: US 2025/0391239 A1
(43) Pub. Date: Dec. 25, 2025

(54) INFORMATION PROCESSING DEVICE AND RECORDING MEDIUM

(71) Applicant: SEGA CORPORATION, Tokyo (JP)

(72) Inventors: Rikito Chikaarashi, Tokyo (JP); Hidenori Saito, Tokyo (JP)

(73) Assignee: SEGA CORPORATION, Tokyo (JP)

(21) Appl. No.: 19/310,326

(22) Filed: Aug. 26, 2025

Related U.S. Application Data
(63) Continuation of application No. PCT/JP2023/041545, filed on Nov. 17, 2023.

(30) Foreign Application Priority Data
Mar. 24, 2023 (JP) 2023-048979

(51) Int. Cl. G07F 17/32

(52) U.S. Cl. CPC G07F 17/3227; G07F 17/3211; G07F 17/329

(57) ABSTRACT

An information processing device includes a controller that restricts a user from playing a lottery game that the user has selected, via a terminal device. from among a plurality of types of lottery games, in a case where the user has not yet played a preset destination lottery game that is not the selected lottery game.

### BACKGROUND

### Technical Field

The present invention relates to an information processing device and a non-transitory computer readable recording medium storing instructions.

### Description of Related Art

There is a known information processing device that executes a lottery game in which a piece of item content (for example, a character) selected by lottery from among a plurality of pieces of item content is granted to a user (for example, Patent Document 1).

### Patent Documents

Patent Document 1: JP 2017-56209 A

### Technological Problem to be Solved by Invention

Even when a game operator (administrator) prepares a specific lottery game that they would proactively like a user to play among a plurality of types of lottery games available to play, there are so many lottery games to choose from that the user may not notice such and may select and play another lottery game.

### SUMMARY

The present invention has been configured in consideration of the above circumstances, and one or more embodiments of the present invention that provide a specific algorithm to modify functionality of a computer to direct the users to a specific lottery game prepared by the game operator.

According to one aspect of the present invention, an information processing device comprises a controller that restricts a user from playing a lottery game that the user has selected, via a terminal device, from among a plurality of types of lottery games, in a case where the user has not yet played a preset destination lottery game that is not the selected lottery game.

Other features of the present invention will become apparent from the Specification of the present invention and the accompanying Drawings.

### BRIEF DESCRIPTION OF DRAWINGS

FIG. 1 is a configuration diagram illustrating one example of an information processing system 1 according to one or more embodiments.

FIG. 2 is a hardware configuration diagram illustrating one example of a computer 50 according to one or more embodiments.

FIG. 3 is a functional block diagram illustrating one example of the server device 20 according to one or more embodiments.

FIG. 4 is a configuration diagram illustrating one example of character information according to one or more embodiments.

FIG. 5 is a configuration diagram illustrating one example of lottery game information according to one or more embodiments.

FIG. 6 is a configuration diagram illustrating one example of guidance setting information according to one or more embodiments.

FIG. 7 is a configuration diagram illustrating one example of competitive game information according to one or more embodiments.

FIG. 8 is a configuration diagram illustrating one example of user information according to one or more embodiments.

FIG. 9 is a functional block diagram illustrating one example of a client terminal 10 according to one or more embodiments.

FIG. 10 is a flowchart illustrating an operational example relating to a lottery game in one or more embodiments.

FIG. 11 is a diagram illustrating a configuration example of a lottery game selection screen 500 in one or more embodiments.

FIG. 12 is a diagram illustrating a configuration example of a restricted lottery game screen 550 in one or more embodiments.

FIG. 13 is a diagram illustrating a configuration example of a message-included lottery game screen 570 in one or more embodiments.

FIG. 14 is a diagram illustrating a configuration example of a destination lottery game's lottery game screen 600 in one or more embodiments.

FIG. 15 is a diagram illustrating a configuration example of a lottery game screen 650 in one or more embodiments.

### DETAILED DESCRIPTION OF EMBODIMENTS

At least the following will become apparent from the description of the present Specification and the accompanying Drawings.

Namely, this is an information processing device that comprises a controller that restricts a user from playing a lottery game that the user has selected, via a terminal device, from among a plurality of types of lottery games, in a case where the user has not yet played a preset destination lottery game that is not the selected lottery game.

According to the information processing device, by presetting a specific lottery game designated by the game operator as the destination lottery game and restricting the user from playing other lottery games until the destination lottery game is played, the user can be guided to the destination lottery game even when there are many options for playable lottery games.

Furthermore, the information processing device may comprise a display device, and in response to the user selecting the lottery game, upon confirming that the user has not yet played the preset destination lottery game that is not the selected lottery game, the controller may cause the display device to display a game screen informing the user that the destination lottery game should be played.

According to the information processing device, it becomes easier to guide a user who has not yet played the destination lottery game to the destination lottery game.

Furthermore, the information processing device may comprise a display device, and in response to the user selecting the lottery game, upon confirming that the user has not yet played the preset destination lottery game that is not the selected lottery game, the controller may cause the display device to display a game screen causing the user to play the destination lottery game.

According to the information processing device, it becomes easier to guide a user who has not yet played the destination lottery game to the destination lottery game.

Furthermore, this is an information processing device that comprises a display device; and a controller that causes the display device to display a game screen notifying a user that a preset destination lottery game should be played in a case where the user has not yet played the preset destination lottery game that is not a lottery game that the user has selected, via a terminal device, from among a plurality of types of lottery games.

According to the information processing device, by presetting a specific lottery game designated by the game operator as the destination lottery game and notifying the user to play the destination lottery game until the destination lottery game is played, the user can be guided to the destination lottery game even when there are many options for playable lottery games.

Furthermore, this is an information processing device that comprises a display device; and a controller that causes the display device to display a game screen causing a user to play a preset destination lottery game in a case where the user has not yet played the preset destination lottery game that is not a lottery game that the user has selected, via a terminal device, from among a plurality of types of lottery games.

According to the information processing device, by presetting a specific lottery game designated by the game operator as the destination lottery game and notifying the user to play the destination lottery game until the destination lottery game is played, and opening a game screen for playing the destination lottery game until the user has finished playing the destination lottery game, the user can be guided to the destination lottery game even when there are many options for playable lottery games.

Furthermore, in the information processing device, the destination lottery game may be a lottery game that is advantageous to the user.

According to the information processing device, a lottery game that is advantageous to the user is preset as the destination lottery game, and the user is guided to that advantageous lottery game, thereby preventing the user from not realizing the existence of a lottery game that is advantageous to the user and from selecting and playing other lottery games.

Furthermore, this is a non-transitory computer readable recording medium storing instructions for causing a computer to execute: restricting a user from playing a lottery game that the user has selected, via a terminal device, from among a plurality of types of lottery games, in a case where the user has not yet played a preset destination lottery game that is not the selected lottery game.

According to the recording medium, it is possible to guide a user to a destination lottery game that the game operator would proactively like the user play, out of a plurality of types of lottery games.

Furthermore, this is a non-transitory computer readable recording medium storing instructions for causing a computer to execute: causing a display device to display a game screen notifying a user that a preset destination lottery game should be played in a case where the user has not yet played the preset destination lottery game that is not a lottery game that the user has selected, via a terminal device, from among a plurality of types of lottery games.

According to the recording medium, it is possible to guide a user to a destination lottery game that the game operator would proactively like the user play, out of a plurality of types of lottery games.

Furthermore, this is a non-transitory computer readable recording medium storing instructions for causing a computer to execute: causing a display device to display a game screen causing a user to play a preset destination lottery game in a case where the user has not yet played the preset destination lottery game that is not a lottery game that the user has selected, via a terminal device, from among a plurality of types of lottery games.

According to the recording medium, it is possible to guide a user to a destination lottery game that the game operator would proactively like the user play, out of a plurality of types of lottery games.

### EMBODIMENTS

An information processing device, a non-transitory computer readable recording medium storing instructions, an information processing method, and an information processing system according to one or more embodiments of the present invention will be described in detail below. Note that the present invention can be broadly applied to recording mediums, information processing devices, information processing methods, information processing systems, and the like that employ a mechanism for granting a user content (for example, a character) selected from a plurality of options.

### System Configuration

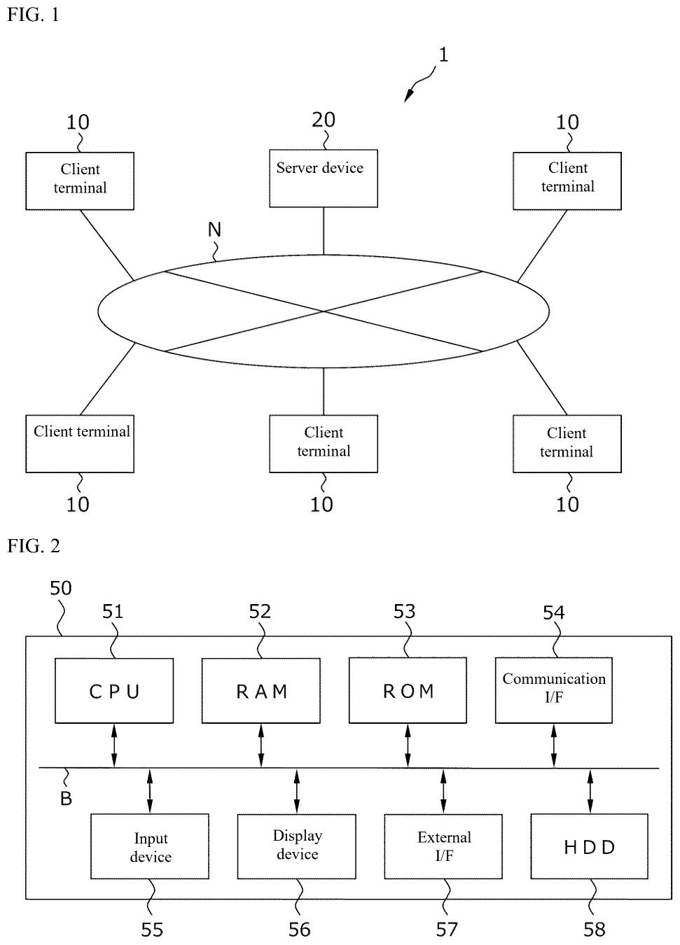

FIG. 1 is a configuration diagram illustrating one example of an information processing system 1 according to one or more embodiments. As illustrated in FIG. 1, in the information processing system 1 according to one or more embodiments, one or more client terminals 10 and a server device 20 are connected via a network N.

The client terminal 10 is a terminal device such as a smartphone, tablet, or PC, or a terminal device such as a home or commercial game console operated by a user. The server device 20 manages and controls games played by users on the client terminals 10, performs billing processes, and the like, within the game. The network N is the Internet or the like, and includes a mobile radio base station and the like.

Note that in addition to the client-server type information processing system 1 illustrated in FIG. 1, the present invention can also be applied to a stand-alone game device by providing a separate mechanism for performing billing processing within the game. The information processing system 1 in FIG. 1 is merely one example, and it goes without saying that various other system configuration examples are possible depending on the application and purpose. For example, the server device 20 in FIG. 1 may be configured in a split manner across multiple computers.

### Hardware Configuration

### Client Terminal and Server Device

FIG. 2 is a hardware configuration diagram illustrating one example of a computer 50 according to one or more embodiments. The client terminal 10 and the server device 20 according to one or more embodiments are realized by, for example, a computer 50 having the hardware configuration illustrated in FIG. 2. Note that the computer 50 is an example of the information processing device.

As illustrated in FIG. 2, the computer 50 includes a CPU 51, a RAM 52, a ROM 53, a communication interface 54, an input device 55, a display device 56, an external interface 57, an HDD 58, and the like, all of which are interconnected via a bus line B. In addition, the server device 20 may be configured to connect and use the input device 55 and the display device 56 when necessary.

The CPU 51 is an arithmetic unit that loads instructions and data from storage devices such as the ROM 53 and the HDD 58 onto the RAM 52 and executes various processes based on the loaded instructions and data, thereby realizing control and functions of the entire computer.

The RAM 52 is one example of a volatile semiconductor memory (storage device) for temporarily storing instructions and data, and is also used as a work area when the CPU 51 executes various processes.

The ROM 53 is one example of a non-volatile semiconductor memory (storage device) that can retain instructions and data even when the power is turned off. The ROM 53 stores instructions and data such as the BIOS executed when the computer 50 is started up, OS settings, and network settings.

The communication interface 54 is an interface for connecting the computer 50 to the network N. This allows the computer 50 to perform data communication via the communication interface 54.

The input device 55 is a device used by a user or a game operator (administrator) to input various data and the like. The input device 55 in one or more embodiments is, for example, an operation device such as a touch panel, operation keys or buttons, a keyboard, or a mouse.

The display device 56 is a device for displaying various types of information on a screen to a user or a game operator (administrator). The display device 56 in one or more embodiments is, for example, a display such as liquid crystal or organic EL.

The external interface 57 is an interface for connecting to an external device so as to enable data communication. This allows the computer 50 to read and/or write from and to a recording medium via the external interface 57. The external device is, for example, a recording medium such as a floppy disk, a CD, a DVD, an SD memory card, or a USB memory.

The HDD 58 is one example of a non-volatile storage device that stores instructions and data. The stored instructions and data include an OS, which is fundamental software that controls the entire computer, applications that provide various functions on the OS, and the like.

Note that instead of the HDD 58, a drive device using a flash memory as a storage medium (for example, a solid state drive: SSD) may be used.

The client terminal 10 and the server device 20 according to one or more embodiments can realize various processes, which will be described later, by executing instructions on the computer 50 having the hardware configuration described above.

### Software Configuration

### Server Device

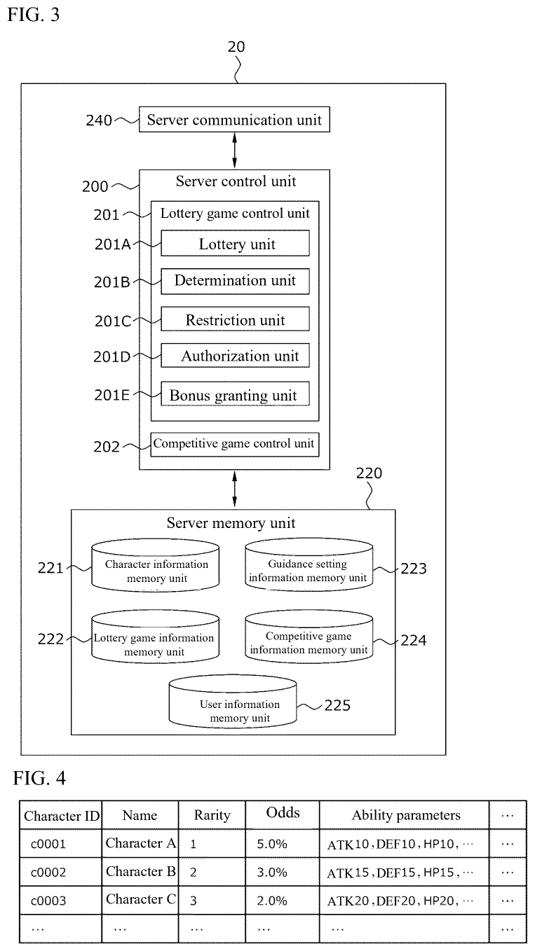

FIG. 3 is a functional block diagram illustrating one example of the server device 20 according to one or more embodiments. The server device 20 according to one or more embodiments is realized by, for example, the functional blocks illustrated in FIG. 3.

The server device 20 according to one or more embodiments realizes a server control unit (or server controller) 200 comprising a CPU, a server memory unit (or server memory) 220, and a server communication unit (or server communication interface) 240 by executing instructions.

The server control unit 200 has a function of executing various processes in the server device 20. The server control unit 200 according to one or more embodiments includes at least a lottery game control unit 201 that executes various processes relating to the lottery game, and a competitive game control unit 202.

The lottery game control unit 201 executes various processes relating to the lottery game. As illustrated in FIG. 3, the lottery game control unit 201 according to one or more embodiments includes at least a lottery unit 201A, a determination unit 201B, a restriction unit 201C, an authorization unit 201D, and a bonus granting unit 201E.

The lottery unit 201A executes a lottery process. For example, the client terminal 10 executes a process of determining by lottery the content to be acquired by the user from among a plurality of types of content that are lottery candidates, based on a game operation received from the user.

The determination unit 201B executes a determination process. For example, based on the game operation received from the user, the client terminal 10 executes a process of determining whether the user has already played a specific lottery game (a destination lottery game) specified by the game operator.

The restriction unit 201C executes a restriction process. For example, when the determination unit 201B determines that the user has not yet played the destination lottery game, a process of restricting the lottery games that the user can play is executed.

The authorization unit 201D executes the permission process. For example, when the determination unit 201B determines that the user has already played the destination lottery game, a process is executed to permit the user to play a lottery game other than the destination lottery game.

The bonus granting unit 201E executes a bonus granting process. For example, when a user plays a lottery game with a bonus among a plurality of types of lottery games that can be played, a process is executed to grant the user a bonus as a “gift.”

The competitive game control unit 202 executes various processes relating to competitive games. Similarly to the lottery game control unit 201, the competitive game control unit 202 in one or more embodiments includes, in addition to a competition unit that executes competition processing, at least a decision unit, a determination unit, a restriction unit, an authorization unit, and a bonus granting unit, all of which are not illustrated.

The server memory unit 220 has a function of storing various types of information in the server device 20. As illustrated in FIG. 3, the server memory unit 220 in one or more embodiments includes a character information memory unit 221, a lottery game information memory unit 222, a guidance setting information memory unit 223, a competitive game information memory unit 224, and a user information memory unit 225.

The character information memory unit 221 is one example of a content information memory unit and stores character information (content information) relating to characters as an example of content. The character information stored in the character information memory unit 221 includes various characters used in the lottery game. The character information stored in the character information memory unit 221 is composed of various data items as shown below.

FIG. 4 is a configuration diagram illustrating one example of character information according to one or more embodiments. The character information illustrated in FIG. 4 includes items such as character ID, name, rarity, and ability parameters.

The character ID is information for uniquely identifying a character. The name is information indicating a character name. The rarity is information indicating a scarcity value of the character. The lottery probability is information indicating a probability that the character will be selected from among a large number of lottery candidates. Here, the higher the rarity of the character, the lower the odds are set to be. The ability parameters are pieces of information that indicate ability values of a character. Here, parameters such as attack power, defense power, HP, and the like of the character are set.

The lottery game information memory unit 222 stores lottery game information relating to the lottery game. The lottery game information stored in the lottery game information memory unit 222 is composed of various data as described below.

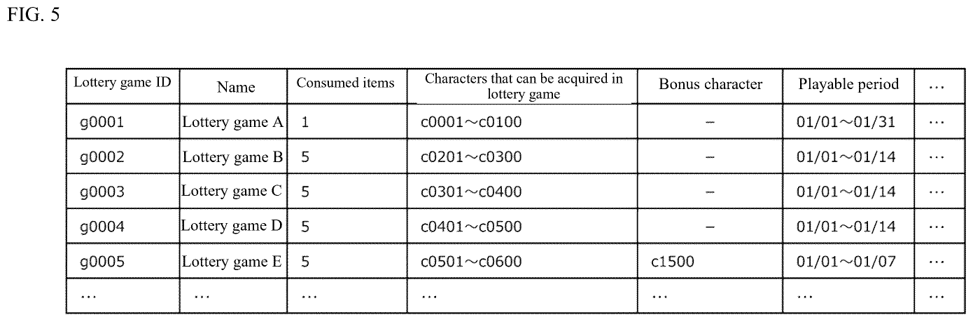

FIG. 5 is a configuration diagram illustrating one example of lottery game information according to one or more embodiments. The lottery game information illustrated in FIG. 5 includes items such as a lottery game ID, a name, a number of consumable items, characters that can be acquired in the lottery game, bonus characters, and a playable period.

The lottery game ID is information for uniquely identifying the lottery game. The name is information indicating a lottery game name. The number of consumable items is information indicating the number of items consumed in one play. The characters that can be acquired in the lottery game are pieces of information that indicate characters that the user can acquire as a lottery result from among the characters set in the character information. The bonus character is information indicating a character that the user will definitely acquire as a bonus, from among the characters set in the character information. Here, the “characters that can be acquired in the lottery game” and the “bonus characters” are set so that they do not overlap, but it is possible to set them so that they do overlap. The playable period is information indicating a period during which the user can play the lottery game.

The guidance setting information memory unit 223 stores guidance setting information relating to the destination lottery game. The guidance setting information stored in the guidance setting information memory unit 223 is composed of various data as shown below.

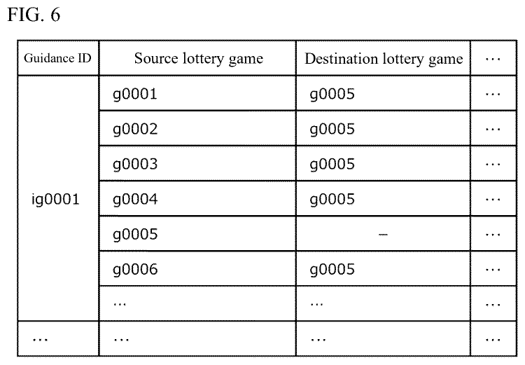

FIG. 6 is a configuration diagram illustrating one example of guidance setting information according to one or more embodiments. The guidance setting information illustrated in FIG. 6 includes, as items, a guidance ID, a source lottery game, a destination lottery game, and the like.

The guidance ID is information for uniquely identifying a guidance rule that associates a guidance source lottery game with a guidance destination lottery game. The source lottery game is information that is set as the “source lottery game” and is a lottery game that can be selected by the user on the lottery game selection screen among the lottery games set in the lottery game information. The destination lottery game is a specific lottery game designated in advance by the game operator among the lottery games set in the lottery game information, and is information that is set in advance as the “destination lottery game.” Here, a specific lottery game (a lottery game with a bonus) that is advantageous to the user is designated in advance by the game operator as a “destination lottery game.”

The competitive game information memory unit 224 stores competitive game information relating to competitive games. The competitive game information stored by the competitive game information memory unit 224 is composed of various data as shown below.

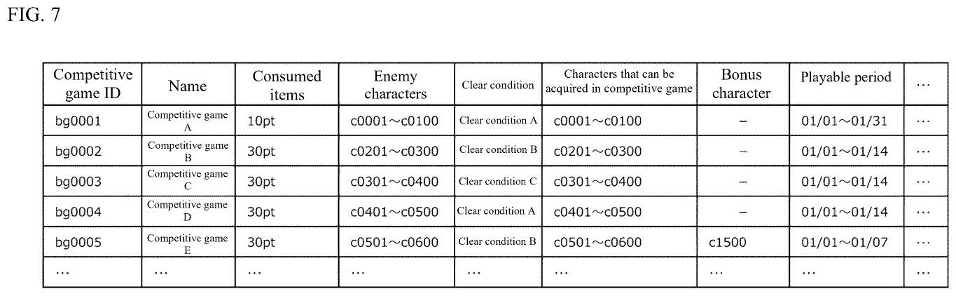

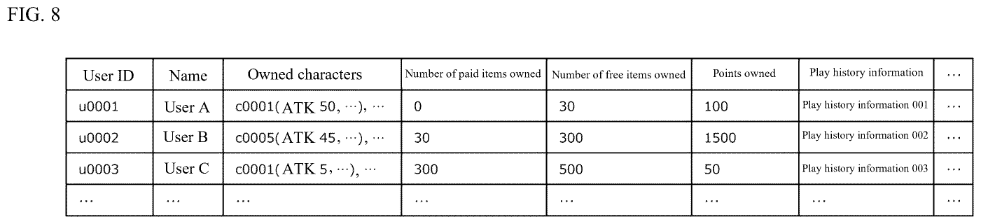

FIG. 7 is a configuration diagram illustrating one example of competitive game information according to one or more embodiments. The competitive game information illustrated in FIG. 7 includes items such as a competitive game ID, a name, a number of points consumed, an enemy character, a clear condition, characters that can be acquired in the competitive game, bonus characters, and a playable period.

The competitive game ID is information for uniquely identifying a competitive game (for example, a “quest”). The name is information indicating the name of the competitive game (for example, the name “quest”). The number of consumed points is information indicating the number of competition points consumed in one play session. The enemy character is information indicating a character that may appear in the competitive game among the characters set in the character information.

The clear condition is information indicating a condition under which a user must clear a competitive game. For example, the conditions for clearing the game may be to defeat all enemy characters that appear, to defeat all enemy characters using the character of the highest rarity owned, or the like.

The characters that can be acquired in the competitive game are pieces of information indicating which of the characters set in the character information can be acquired by the user. Each character that can be acquired has a drop rate. Therefore, when a character is defeated, whether the user can acquire the character is determined according to the drop rate.

The bonus character is information that indicates which of the characters set in the character information the user is ensured to obtain as a bonus when clearing a match. Here, the “characters that can be acquired in the competitive game” and the “bonus characters” are set so that they do not overlap, but it is possible to set them so that they do overlap. The playable period is information indicating a period during which the user can play the competitive game.

The user information memory unit 225 stores user information on users who play the lottery game. The user information stored in the user information memory unit 225 is made up of various types of data shown below.

FIG. 8 is a configuration diagram illustrating one example of user information according to one or more embodiments. The user information illustrated in FIG. 8 includes items such as a user ID, a name, owned characters, a number of owned paid items, a number of owned free items, a number of owned points, and play history information.

The user ID is information for uniquely identifying a user. The name is information indicating a user name. The owned characters are pieces of information that indicate which of the characters set in the character information owned by the user. The number of paid items owned is information that indicates the number of paid items (billed items) that the user has acquired through purchase. This is information indicating the number of free items (non-billed items) that the user has acquired without purchasing. The number of owned points is information indicating the amount of competition points owned by the user. The play history information is information relating to the play history of lottery games that the user has played so far. For example, information such as when which game was played, when which character was used to play, what game results were obtained, how many items and competition points were consumed, how often characters were used, the purchase amount of paid items, and the like are set as the play history.

The server communication unit 240 has a function of communicating with the client terminal 10 via the network N.

Note that as described above, in the information processing system 1 of one or more embodiments, the server device 20 performs control and the like relating to the lottery game, and the client terminal 10 may perform various controls and processing. Specifically, the lottery game control unit, lottery unit, determination unit, restriction unit, authorization unit, and at least some of the bonus granting unit, and the competitive game control unit, competition unit, decision unit, determination unit, restriction unit, authorization unit, and bonus granting unit may be configured not to be provided in the server control unit 200 of the server device 20, but to be provided in the client control unit 100 of the client terminal 10.

### Client Terminal

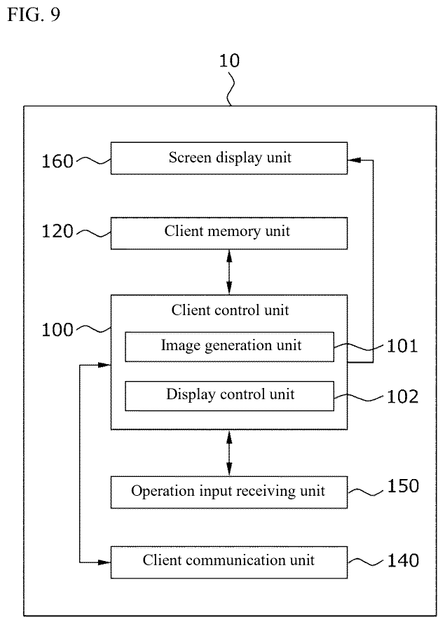

FIG. 9 is a functional block diagram illustrating one example of the client terminal 10 according to one or more embodiments. The client terminal 10 according to one or more embodiments is realized by, for example, the functional blocks illustrated in FIG. 9.

The client terminal 10 according to one or more embodiments realizes a client control unit (or client controller) 100 comprising a CPU, a client memory unit (or client memory) 120, a client communication unit (or client communication interface) 140, an operation input receiving unit (or I/O interface) 150, and a screen display unit (or display device) 160 by executing instructions.

The client control unit 100 has a function of executing various processes in the client terminal 10. The client control unit 100 in one or more embodiments includes at least an image generation unit 101 and a display control unit 102.

The image generation unit 101 generates image data for displaying various screens relating to the lottery game and the competitive game on the client terminal 10 based on the processing results of the lottery game control unit 201 and the competitive game control unit 202 of the server device 20.

The display control unit 102 controls the screen display on the client terminal 10 by outputting various screens relating to the lottery game and the competitive game to the screen display unit 160 based on the image data generated by the image generation unit 101.

The operation input receiving unit 150 accepts operation input from a user. When the user performs a touch operation on the screen, the operation input receiving unit 150 according to one or more embodiments receives the operation input from the user via the touch panel.

The client memory unit 120 stores various instructions and various information required by the client terminal 10. The various instructions include programs that allow the user to play lottery games and competitive games. The various information includes, similarly to the server memory unit 220, all or part of the character information, lottery game information, guidance setting information, competitive game information, and user information. That is, the client memory unit 120 also functions as a character information memory unit, a lottery game information memory unit, a guidance setting information memory unit, a competitive game information memory unit, and a user information memory unit.

The client communication unit 140 communicates with the server device 20 via the network N.

The screen display unit 160 performs screen display on the client terminal 10 by receiving a control signal from the display control unit 102.

Note that as described above, in the information processing system 1 according to one or more embodiments, the client terminal 10 performs image generation, display control, and the like, but the server device 20 may perform various controls and processing. Specifically, at least a part of the image generation unit and the display control unit may be configured not to be provided in the client control unit 100 of the client terminal 10, but to be provided in the server control unit 200 of the server device 20.

### System Overview

An overview of the information processing system 1 according to one or more embodiments will be described. In the information processing system 1 of one or more embodiments, a user can play a lottery game by consuming at least one of a paid item and a free item that the user owns.

In the information processing system 1 of one or more embodiments, a plurality of types of lottery games that can be played are provided. Among the plurality of types of lottery games, there is also provided a specific lottery game that the game operator (administrator) would proactively like the user play. A user can select and play any of a plurality of types of lottery games.

However, even when a game operator prepares a specific lottery game that they would proactively like the user to play among the plurality of types of lottery games, there are many options for the lottery games that can be played, and thus the user may not notice that specific lottery game. Such a user may select and play a lottery game other than that specific lottery game.

Therefore, in one or more embodiments, a specific lottery game designated by the game operator is set in advance in the guidance setting information as the destination lottery game, and the user is restricted from playing any other lottery games until the destination lottery game is finished, or is notified to play the destination lottery game, or a game screen that allows the user to play the destination lottery game is forcibly opened. This makes it possible to guide the user to the destination lottery game even when there are many options for playable lottery games.

In addition, in one or more embodiments, a lottery game that is advantageous to the user (for example, a lottery game that is advantageous to the user, such as a lottery game with a bonus) is set in advance as the destination lottery game, so that the user can be guided to the advantageous lottery game. In this way, it is possible to prevent the user from not noticing the existence of a lottery game that is advantageous to the user and from selecting and playing a lottery game other than that.

Furthermore, in the information processing system 1 of one or more embodiments, a user can play a competitive game by spending competition points that the user owns. Consumed competition points are automatically restored over time, and thus users can play the competitive game repeatedly. Multiple types of playable competitive games are available, and thus the user can select and play any of the plurality of types of competitive games. In the selected competitive game, the user is able to use characters acquired in other competitive games or lottery games (or others' helper characters) to fight against enemy characters and the like that appear during the game.

### System Operation

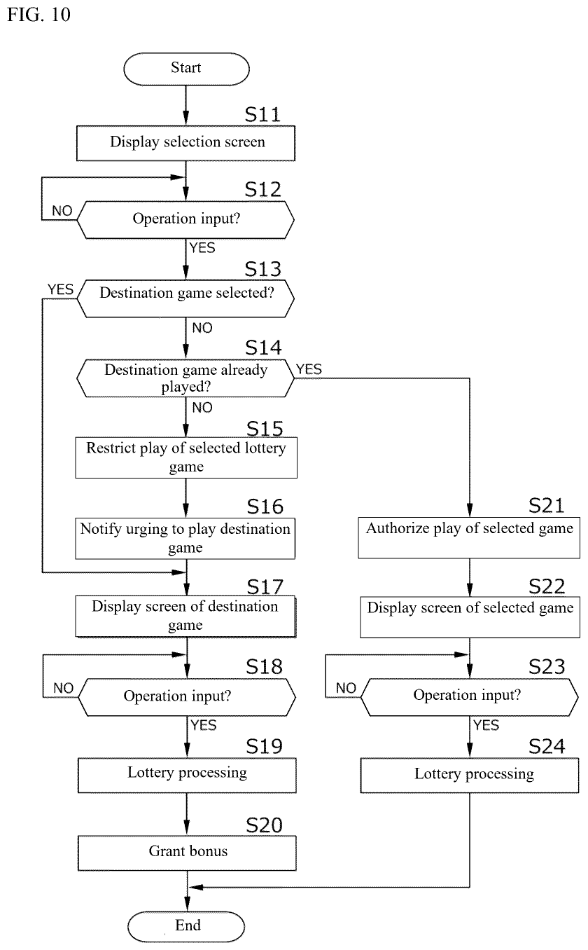

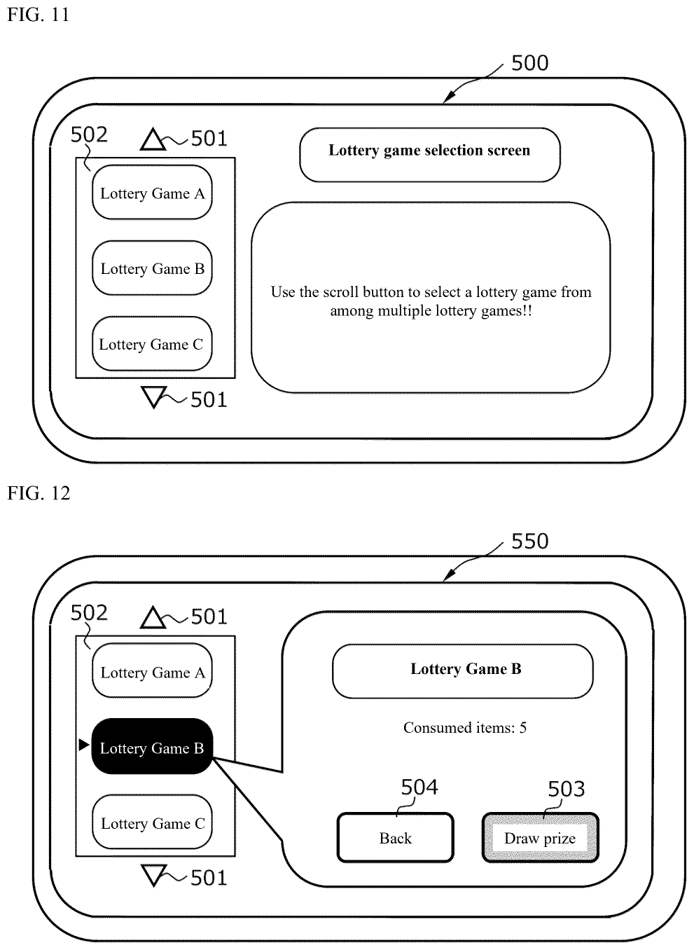

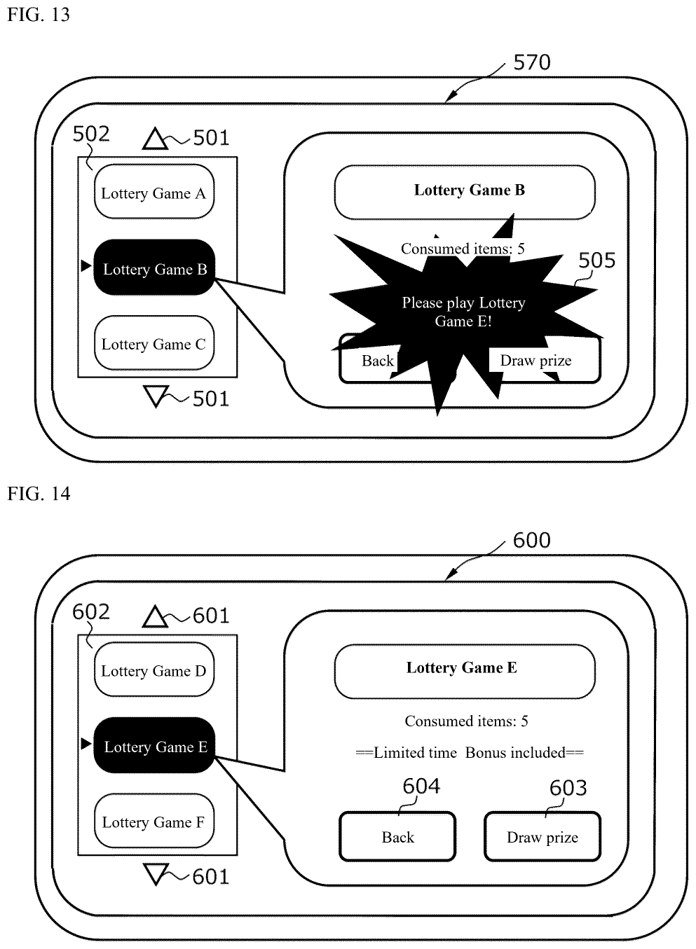

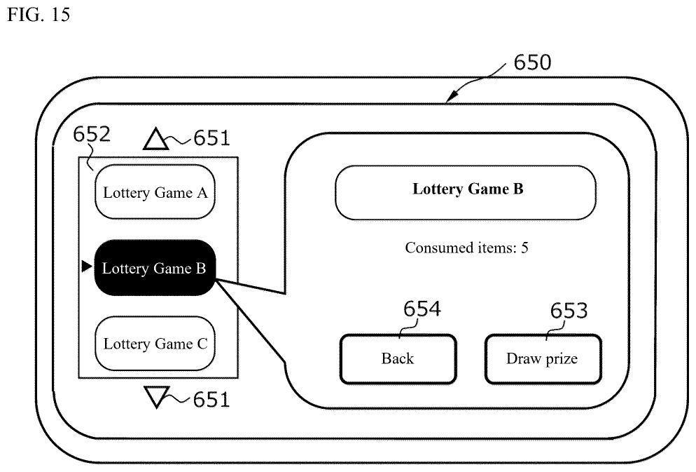

Operations relating to the lottery game in one or more embodiments will be described using FIG. 10 to FIG. 15. FIG. 10 is a flowchart illustrating an operational example relating to a lottery game in one or more embodiments. FIG. 11 is a diagram illustrating a configuration example of a lottery game selection screen 500 in one or more embodiments. FIG. 12 is a diagram illustrating a configuration example of a restricted lottery game screen 550 in one or more embodiments. FIG. 13 is a diagram illustrating a configuration example of a message-included lottery game screen 570 in one or more embodiments. FIG. 14 is a diagram illustrating a configuration example of a destination lottery game's lottery game screen 600 in one or more embodiments. FIG. 15 is a diagram illustrating a configuration example of a lottery game screen 650 in one or more embodiments. In the following, a specific example will be described in which a “lottery game with a bonus” that is advantageous to the user is set in advance as the “destination lottery game.”

### EXAMPLES

First, as illustrated in FIG. 10, when the user performs an operation to start a lottery game on a menu screen not illustrated, the operation input receiving unit 150 receives the user's operation input, and the display control unit 102 of the client terminal 10 displays the lottery game selection screen 500 illustrated in FIG. 11 on the screen display unit 160 based on the image data generated by the image generation unit 101 (step S11).

As illustrated in FIG. 11, a lottery game selection screen 500 displays a scroll button 501 and a list 502 of selection candidate lottery games. When the user operates a scroll button 501 on the lottery game selection screen 500, the selection candidate lottery games are moved up and down in a list 502 and displayed in sequence.

Next, the determination unit 201B of the server device 20 receives user operation information from the client terminal 10 and determines whether the user has performed an operation to select any one of the plurality of types of lottery games in the list 502 on the lottery game selection screen 500 illustrated in FIG. 11 (step S12).

Next, when the user performs an operation to select any of the lottery games (step S12: YES), the determination unit 201B of the server device 20 determines whether the user has selected the destination lottery game (step S13).

That is, the determination unit 201B of the server device 20 references the guidance setting information illustrated in FIG. 6, and when the lottery game selected by the user is the source lottery game, if there is an associated destination lottery game, then it determines that the user did not select the destination lottery game, and if there is no associated destination lottery game, then it determines that the user selected the destination lottery game.

As a result of this determination, when it is determined that the user has selected the destination lottery game (step S13: YES), the process proceeds to step S17, which will be described later. Conversely, when it is determined that the user has not selected the destination lottery game (step S13: NO), the process proceeds to the next step S14.

Next, the determination unit 201B of the server device 20 determines whether the user has already played the destination lottery game (step S14), when the user has not selected the destination lottery game (step S13: NO).

That is, the determination unit 201B of the server device 20 references the guidance setting information illustrated in FIG. 6, and when the lottery game selected by the user is the guidance source lottery game, identifies the destination lottery game associated therewith. Then, by referring to the play history information set in the user information illustrated in FIG. 8, when the destination lottery game is present among the lottery games that have been played and are included in the play history information, it is determined that the user has already played the destination lottery game. Conversely, when the destination lottery game is not present among the lottery games that have been played and are included in the play history information, it is determined that the user has not yet played the destination lottery game.

When, as a result of this determination, it is determined that the user has already played the destination lottery game (step S14: YES), the process proceeds to step S21, which is described later. In contrast, when it is determined that the user has not yet played the lottery game to which the user is being guided (step S14: NO), the process proceeds to the next step S15.

Next, when the user has not yet played the destination lottery game (step S14: NO), the restriction unit 201C of the server device 20 restricts the user from playing the lottery game selected by the user (step S15).

That is, the restriction unit 201C of the server device 20 requests the display control unit 102 of the client terminal 10 to display a lottery game screen configured to prevent a user from playing the lottery game selected by the user. Then, the display control unit 102 of the client terminal 10 displays the restricted lottery game screen 550 illustrated in FIG. 12 on the screen display unit 160 based on the image data generated by the image generation unit 101 in accordance with a request from the restriction unit 201C.

As illustrated in FIG. 12, the restricted lottery game screen 550 displays a scroll button 501, a list 502 of selection candidate lottery games, a lottery button 503 for confirming the start of the lottery, and a cancel button 504 for canceling the selection of the lottery game. When the user presses the lottery button 503, the lottery starts, and when the user presses the cancel button 504, the lottery game selection screen 500 illustrated in FIG. 11 is displayed.

As illustrated in FIG. 12, the restricted lottery game screen 550 in one or more embodiments shows a case where “Lottery Game B” in the list 502 has been selected by the user. The “Lottery Game B” selected by the user is not the destination lottery game, and the user has not yet played the destination lottery game, and thus the lottery button 503 is grayed out, and the user cannot press the lottery button 503. That is, the user is restricted from playing the “Lottery Game B” selected by the user.

As a result, even when there are many selection candidate lottery games on the list 502, by restricting the user from playing any lottery games other than the destination lottery game, it is possible to guide the user to the destination lottery game.

Next, the display control unit 102 of the client terminal 10 causes the screen display unit 160 to display a message-included lottery game screen 570 as illustrated in FIG. 13 to notify the user that play of the lottery game selected by the user has been restricted and that the user should play destination lottery game (step S16).

As illustrated in FIG. 13, message-included lottery game screen 570 displays a message 505 urging the user to play the destination lottery game. Here, the user is restricted from playing the “Lottery Game B” selected by the user, and is notified on the screen that the user should play a “Lottery Game E” (a lottery game with a bonus), which is the destination associated with the source “Lottery Game B.”

In this way, even when the user selects a lottery game other than the destination lottery game, the user can be directed to the destination lottery game by giving a notification urging the user to play the destination lottery game.

Next, the display control unit 102 of the client terminal 10 causes the screen display unit 160 to display the destination lottery game screen 600, as illustrated in FIG. 14, based on the image data generated by the image generation unit 101 (step S17).

Note that when the user does not select the destination lottery game in the processing of step 13 described above, and the user has not yet played the destination lottery game in the processing of step 14 described above, then after the message-included lottery game screen 570 as illustrated in FIG. 13 is displayed in the processing of step 16 described above, the destination lottery game screen 600 as illustrated in FIG. 14 is forcibly (automatically) displayed. Therefore, even when there are many selection candidate lottery games in the list 502, it is possible to guide the user to the destination lottery game.

As illustrated in FIG. 14, the destination lottery game's lottery game screen 600 displays a scroll button 601, a list 602 of selection candidate lottery games, a lottery button 603 for confirming the start of the lottery, and a cancel button 604 for canceling the selection of the lottery game. When the user presses the lottery button 603, the lottery starts, and when the user presses the cancel button 604, the lottery game selection screen 500 illustrated in FIG. 11 is displayed.

In the destination lottery game's lottery game screen 600 in one or more embodiments, as illustrated in FIG. 14, a lottery game screen of the “Lottery Game E” is displayed as the destination lottery game. The destination “Lottery Game E” is a lottery game including a special bonus that is advantageous to the user.

Next, the determination unit 201B of the server device 20 receives user operation information from the client terminal 10 and determines whether the user has pressed the lottery button 603 on the destination lottery game's lottery game screen 600, as illustrated in FIG. 14 (step S18).

Next, when the user presses the lottery button 603 (step S18: YES), the lottery unit 201A of the server device 20 executes a lottery process in the destination lottery game (step S19).

That is, the lottery unit 201A of the server device 20 references the lottery game information illustrated in FIG. 5 and the user information illustrated in FIG. 8 and reduces the number of items required to play the destination lottery game once from the number of at least one of paid items and free items possessed by the user, and then selects one of the characters that can be acquired in the destination lottery game based on the odds for each character, and grants the character to the user. Then, the user information of the user is updated to add the granted character as a character owned by the user. Furthermore, the play history of the user information is updated to add the destination lottery game as a game that has already been played.

Next, the bonus granting unit 201E of the server device 20 executes a process of granting a bonus character to the user who played the destination lottery game, in addition to the character granted in the destination lottery game (step S20).

That is, the bonus granting unit 201E of the server device 20 references the lottery game information illustrated in FIG. 5, identifies a bonus character associated with the destination lottery game, and grants the character to the user. Then, the user information of the user is updated to add the granted character as a character owned by the user.

Next, when the user has already played the destination lottery game (step S14: YES), the authorization unit 201D of the server device 20 permits the user to play the lottery game selected by the user (step S21).

That is, the authorization unit 201D of the server device 20 requests the display control unit 102 of the client terminal 10 to display a lottery game screen configured to allow the user to play the lottery game selected by the user.

Next, the display control unit 102 of the client terminal 10 displays the lottery game screen 650 illustrated in FIG. 15 on the screen display unit 160 based on the image data generated by the image generation unit 101 in accordance with the request from the authorization unit 201D (step S22).

As illustrated in FIG. 15, the lottery game screen 650 displays a scroll button 651, a list 652 of selection candidate lottery games, a lottery button 653 to confirm the start of the lottery, and a cancel button 654 to cancel the lottery game selection. When the user presses the lottery button 653, the lottery begins, and when the user presses the cancel button 654, the lottery game selection screen 500 illustrated in FIG. 11 is displayed.

The lottery game screen 650 in one or more embodiments, similarly to the lottery game screen 550 illustrated in FIG. 12, shows a case in which “Lottery Game B” in the list 502 is selected by the user, as illustrated in FIG. 15. However, unlike the lottery game screen 550 illustrated in FIG. 12, although the “Lottery Game B” selected by the user is not the destination lottery game, the user is able to press the lottery button 653 because the user has already played the destination lottery game. That is, the user is allowed to play the “Lottery Game B” selected by the user.

Next, the determination unit 201B of the server device 20 determines whether the user pressed the lottery button 653 on the lottery game screen 650 illustrated in FIG. 15 by receiving the user's operation information from the client terminal 10 (step S23).

Next, the lottery unit 201A of the server device 20 executes the lottery process in the lottery game selected by the user (step S24) when the user presses the lottery button 653 (step S23: YES).

That is, the lottery unit 201A of the server device 20 refers to the lottery game information shown in FIG. 5 and the user information shown in FIG. 8, and reduces the number of items required to play the lottery game selected by the user once from the number of at least one of paid items and free items possessed by the user, and then selects one of the characters that can be acquired in the selected lottery game based on the odds for each character, and grants the character to the user. Then, the user information of the user is updated to add the granted character as a character owned by the user. Also, by updating the play history of that user information, the selected lottery game is added as having been played.

### Modification 1: Restriction+Screen Transition

In the example described above, when the user does not select a destination lottery game in the processing of step 13 described above and the user has not yet played the destination lottery game in the processing of step 14 described above, the user is notified in the processing of step 16 described above that they should play the destination lottery game, but it is also possible to omit the processing of step 16. That is, after the restricted lottery game screen 550 illustrated in FIG. 12 is displayed in the processing of step 15 described above, the destination lottery game screen 600, illustrated in FIG. 14, may be forcibly (automatically) displayed in the processing of step 17 described above. Thus, even when there are many selection candidate lottery games in the list 502, it is possible to guide the user to the destination lottery game.

### Modification 2: Restriction+Notification

In the example described above, when the user does not select a destination lottery game in the processing of step 13 described above and the user has not yet played the destination lottery game in the processing of step 14 described above, after which the message-included lottery game screen 570 as illustrated in FIG. 13 is displayed in the processing of step 16 described above, and then the destination lottery game screen 600 as illustrated in FIG. 14 is forcibly displayed in the processing of step 17 described above, but it is also possible to omit the processing of step 17. That is, after the restricted lottery game screen 550 illustrated in FIG. 12 is displayed in the processing of step 15 described above, the message-included lottery game screen 570 illustrated in FIG. 13 may be displayed in the processing of step 16 described above, and then the processing of the flowchart illustrated in FIG. 10 may be terminated. Thus, even when there are many selection candidate lottery games in the list 502, it is possible to guide the user to the destination lottery game.

### Modification 3: Restriction Only

In the example described above, when the user has not selected the destination lottery game in the above processing of step 13 and the user has not yet played the destination lottery game in the above processing of step 14, the restricted lottery game screen 550 illustrated in FIG. 12 is displayed in the above processing of step 15, after which the message-included lottery game screen 570 illustrated in FIG. 13 is displayed in the processing of the above step 16, and then the game screen 600 of the destination lottery game illustrated in FIG. 14 is forcibly displayed in the processing of the above step 17, this processing of step 16 and step 17 may be omitted. That is, after the restricted lottery game screen 550 illustrated in FIG. 12 is displayed in the processing of step 15 described above, the processing of the flowchart illustrated in FIG. 10 may be ended. Thus, even when there are many selection candidate lottery games in the list 502, it is possible to guide the user to the destination lottery game.

### Modification 4: Notification+Screen Transition

In the example described above, when the user did not select the destination lottery game in the processing of step 13 above and the user has not yet played the destination lottery game in the processing of step 14 above, the restricted lottery game screen 550 illustrated in FIG. 12 is displayed in step 15 described above, after which the user is notified that they should play the destination lottery game in the processing of step 16 described above, but this processing of step 15 can be omitted. That is, after the message-included lottery game screen 570 illustrated in FIG. 13 is displayed in the processing of step 16 above, the destination lottery game screen 600 illustrated in FIG. 14 may be forcibly displayed in the processing of step 17 above. Thus, even when there are many selection candidate lottery games in the list 502, it is possible to guide the user to the destination lottery game.

### Modification 5: Notification Only

In the example described above, when the user has not selected the destination lottery game in the above processing of step 13 and the user has not yet played the destination lottery game in the above processing of step 14, the restricted lottery game screen 550 illustrated in FIG. 12 is displayed in the above processing of step 15, after which the message-included lottery game screen 570 illustrated in FIG. 13 is displayed in the above step 16 process, and then the game screen 600 of the destination lottery game illustrated in FIG. 14 is forcibly displayed in the above step 17 process, but it is possible to omit this processing of step 15 and step 17. That is, the process of the flowchart illustrated in FIG. 10 may be terminated after the message-included lottery game screen 570 illustrated in FIG. 13 is displayed in the processing of step 16 described above. Thus, even when there are many selection candidate lottery games in the list 502, it is possible to guide the user to the destination lottery game.

### Modification 6: Screen Transition Only

In the example described above, when the user has not selected the destination lottery game in the above processing of step 13 and the user has not yet played the destination lottery game in the above processing of step 14, the restricted lottery game screen 550 illustrated in FIG. 12 is displayed in the above processing of step 15, after which the message-included lottery game screen 570 illustrated in FIG. 13 is displayed in the above step 16 process, and then the game screen 600 of the destination lottery game illustrated in FIG. 14 is forcibly displayed in the above step 17 process, this processing of step 15 and step 16 may be omitted. That is, after the destination lottery game screen 600 illustrated in FIG. 14 is forcibly displayed in the processing of step 17 described above, the lottery processing (step S19) and the bonus granting processing (step S20) are executed, and then the processing of the flowchart illustrated in FIG. 10 may be terminated. Thus, even when there are many selection candidate lottery games in the list 502, it is possible to guide the user to the destination lottery game.

### Summary

Thus, according to the information processing system 1 of one or more embodiments, a specific lottery game designated by the game operator is set in advance as the destination lottery game, and the system can restrict the user from playing other lottery games until the destination lottery game is finished, or can notify the user to play the destination lottery game, or can forcibly open a game screen that allows the user to play the destination lottery game, so that even when there are many options for lottery games that can be played, the user can be directed to the destination lottery game.

### Other Embodiments

The above embodiments are provided to facilitate understanding of the present invention and should not be interpreted as limiting the present invention. The present invention can be modified or improved without departing from the spirit thereof, and the present invention also includes equivalents thereof. In particular, the embodiments described below are also included in the present invention. That is, the present invention can be configured by appropriately combining the above embodiments with the embodiments described below.

Furthermore, it is also possible to configure various inventions by appropriately combining multiple invention defining matters disclosed in the above embodiments. For example, the invention may be configured by removing some of the invention defining matters from all of the invention defining matters disclosed in the above embodiments, or the invention may be configured by appropriately combining all of the invention defining matters disclosed in the above embodiments with the invention defining matters disclosed in the embodiments described below.

### Destination Lottery Game

In the example described above, an example was given of a case in which a “lottery game that is advantageous to the user” (for example, a lottery game with a bonus) is preset as the “destination lottery game,” but the present invention is not limited to this.

For example, it is possible to set in advance as “destination lottery games” a lottery game with the most recent release date (the date when it became playable), the lottery game whose playable period (for example, an event period) ends soonest, a lottery game with the number one or highest popularity ranking (the lottery game that is number one or highest in the ranking of the most played by all users), a lottery game with the lowest or lowest popularity ranking (the lottery game that is lowest or lower in the ranking of the most played by all users), and the like.

In addition, in the example described above, an example was given of a case where there is only one “destination lottery game” associated with the “source lottery game” in the guidance setting information, but the present invention is not limited to this.

For example, it is possible to set a plurality of types of lottery games as a destination group in the guidance setting information in association with the “source lottery game.” In this case, in the processing of step 13 described above, it is determined whether any of the lottery games in the destination group has been selected. In addition, in the processing of step 14 described above, it is determined whether all the lottery games in the destination group have already been played. In addition, in the processing of step 16 described above, a notification is given to encourage the player to play any lottery games that have not yet been played among the lottery games in the destination group. In the processing of step 17 described above, a lottery game screen of a lottery game that has not yet been played among the lottery games in the destination group is displayed.

### Lottery Game That is Advantageous to the User

In the above embodiments, the case where the lottery game with a bonus is a “lottery game that is advantageous to the user” has been described as an example, but the present invention is not limited to this.

For example, among multiple types of lottery games to be selected, it is possible preset a lottery game in which the odds of a specific character having a highest rarity (for example, a featured character being proactively promoted) are set high, a lottery game in which the odds of drawing a character group having the highest rarity are set high, a lottery game in which a large number of characters can be acquired per number of items consumed, a lottery game in which a large number of characters can be acquired when playing a lottery game with paid items (billed items), a lottery game in which the odds of drawing a specific character having the highest rarity are set high when playing a lottery game with paid items (billed items), a lottery game in which the odds of drawing a character group having the highest rarity are set high when playing a lottery game with paid items (billed items), a lottery game in which a small number of items are consumed per play, a lottery game in which the advantage becomes greater as the stages progress, or the like as the “lottery game that is advantageous to the user.”

### Competitive Game Guidance

In the embodiments described above, an example was given of a case in which a specific lottery game that the game operator (administrator) proactively wants the user to play is preset as a “destination lottery game,” but the present invention is not limited to this.

For example, a game operator (administrator) may prepare a specific competitive game that they would proactively like the user play, similarly to a lottery game. Even in such cases, even when the game operator prepares a specific competitive game among multiple playable types of competitive games (for example, a “quest”), there are so many competitive games to choose from that the user may not notice such and may select and play a different competitive game.

Therefore, a specific competitive game designated by the game operator is set in advance in the guidance setting information as the destination competitive game, and the user is restricted from playing any other competitive games until the destination competitive game is finished, or is notified to play the destination competitive game, or is forced to open to a game screen that allows the user to play the destination competitive game, and thus even when there are many playable competitive games to choose from, it is possible to guide the user to the destination competitive game.

Specifically, the competitive game control unit 202 (determination unit) of the server device 20 determines whether the user has already played the destination quest when the user selects a quest other than a preset destination quest from among multiple types of quests. Then, the competitive game control unit 202 (restriction unit) of the server device 20 restricts the user from playing the selected quest when it is determined that the quest has not yet been played. In addition, when it is determined that the quest has not yet been played, the display control unit 102 may display a game screen that notifies the user that the destination quest should be played, or may display a game screen that allows the user to play the destination quest.

For example, the “destination quest” may be set in advance as the quests with the most recent release date (the date when the quest became playable), the quests closest to the last day of the playable period (for example, the event period), the quests with the highest popularity ranking (the quests ranked first or highest in the ranking of the most played quests by all users), or the quests with the lowest popularity ranking (the quests ranked last or lowest in the ranking of the most played quests by all users), and the like.

Also, a “competitive game (quest) that is advantageous to the user” (for example, a competitive game with a bonus) may be set in advance as a “destination competitive game (quest).” In this case, for example, among the plurality of types of quests that are available for selection, quests that have a high probability of acquiring (dropping) a specific character having a highest rarity, quests that have a high probability of acquiring (dropping) a group of characters having a highest rarity, quests that allow a large number of characters to be acquired per amount of stamina consumed, quests that allow a large number of characters to be acquired (dropped), quests that allow low amounts of stamina to be consumed per play, quests that become more advantageous as the stage progresses, and the like can be set in advance as “competitive games (quests) that are advantageous to the user.”

### Content Pack Guidance

In the embodiments described above, an example was given of a case in which a specific lottery game that the game operator (administrator) proactively wants the user to play is preset as a “destination lottery game,” but the present invention is not limited to this.

For example, a game operator (administrator) may prepare a specific content pack (one or more characters or items sold as a set) that the game operator (administrator) would proactively like the user purchase, similarly to a lottery game. Even in such cases, even when the game operator prepares such a specific content pack among multiple types of content packs available for purchase, there are so many content pack options that the user may not notice such and may select and purchase a different content pack.

Therefore, by presetting a specific content pack designated by the game operator as the destination content pack, and restricting the user from purchasing any other content packs until the destination content pack has been purchased, or by notifying the user to purchase the destination content pack, or by forcing the user to open to a purchase screen that allows the user to purchase the destination content pack, it becomes possible to guide the user to the destination content pack even when there are many options for content packs available for purchase.

Specifically, the server control unit 200 or the client control unit 100 is configured to include a sales control unit (including at least a sales unit, a determination unit, a restriction unit, an authorization unit, and a bonus granting unit). In addition, the server memory unit 220 or the client memory unit 120 is configured to have a content pack information memory unit that stores content pack information (for example, similarly to lottery game information and competitive game information, various information is set corresponding to multiple types of content packs including content packs with a bonus). For example, the sales control unit (determination unit) of the server device 20 determines whether the user has already purchased the destination content pack when the user selects a content pack other than a preset destination content pack from among multiple types of content packs. Then, when it is determined that the selected content pack has not yet been purchased, the sales control unit (restriction unit) of the server device 20 restricts the user from purchasing the selected content pack. When it is determined that the user has not yet purchased the content pack, the display control unit 102 can display a game screen that notifies the user that the user should purchase the destination content pack, or display a sales screen to allow the user to purchase the destination content pack.

It is also possible to preset as the “destination content pack” the content pack with the most recent release date (the date it became available for purchase), the content pack whose purchase period (for example, an event period) is about to end, a content pack ranked first or highly in popularity (the content pack ranked first or highly in order of the number of purchases by all users), a content pack ranked last or lowest in popularity (the content pack ranked last or lowest in order of the number of purchases by all users), and the like.

Also, a “content pack that is advantageous to the user” (for example, a content pack with a bonus) may be set in advance as a “destination content pack.” In this case, for example, among the plurality of types of content packs that are available as selection candidates, it is possible to set in advance as “content packs that are advantageous to the user” such things as a content pack that contains a specific piece of content having a highest rarity, a content pack that contains a group of contents having a highest rarity, a content pack with a large number of pieces of content that can be acquired, a content pack with a low purchase price per piece of content, a content pack that becomes more advantageous as the stage progresses, and the like

### System Configuration

In the example described above, a distributed network system using blockchain technology (distributed ledger technology) may be adopted instead of a centralized network system equipped with a server device. In a distributed network system, various information stored in a server device in a centralized network system is distributed and stored in each terminal connected peer-to-peer (P2P). By using blockchain technology, various information can be managed in a mutual monitoring format, making it possible to prevent unauthorized data tampering and the like. In addition, content (characters, items, and the like) that utilizes blockchain technology may be issued and distributed as non-fungible tokens (non-fungible tokens: NFTs), making it possible to increase the asset value of the content.

### Content

In the above embodiments, a character is used as one example of content, but the present invention is not limited to this. For example, the content may be various data such as items, cards, figures, avatars, images, music, scenarios, and quests, or instructions such as apps.

### DESCRIPTION OF REFERENCE NUMERALS

1 Information processing system, 10 Client terminal, 20 Server device, 50 Computer, 51 CPU, 52 RAM, 53 ROM, 54 Communication interface, 55 Input device, 56 Display device, 57 External interface, 58 HDD, 100 Client control unit, 101 Image generation unit, 102 Display control unit, 120 Client memory unit, 140 Client communication unit, 150 Operation input receiving unit, 160 Screen display unit, 200 Server control unit, 201 Lottery game control unit, 201A Lottery unit, 201B Determination unit, 201C Restriction unit, 201D Authorization unit, 201E Bonus granting unit, 202 Competitive game control unit, 220 Server memory unit, 221 Character information memory unit, 222 Lottery game information memory unit, 223 Guidance setting information memory unit, 224 Competitive game information memory unit, 225 User information memory unit, 240 Server communication unit, 500 Lottery game selection screen, 501 Scroll button, 502 List, 503 Lottery button, 504 Cancel button, 505 Message, 550 Restricted lottery game screen, 570 Message-included lottery game screen, 600 Destination lottery game's lottery game screen, 601 Scroll button, 602 List, 603 Lottery button, 604 Cancel button, 650 Lottery game screen, 651 Scroll button, 652 List, 653 Lottery button, 654 Cancel button, B Bus line, N Network

What is claimed is:

1. An information processing device comprising:
a controller that restricts a user from playing a lottery game that the user has selected, via a terminal device, from among a plurality of types of lottery games, in a case where the user has not yet played a preset destination lottery game that is not the selected lottery game.

2. The information processing device according to claim 1, further comprising:
a display device, wherein
in response to the user selecting the lottery game, upon confirming that the user has not yet played the preset destination lottery game that is not the selected lottery game, the controller causes the display device to display a game screen informing the user that the destination lottery game should be played.

3. The information processing device according to claim 1, further comprising:
a display device, wherein
in response to the user selecting the lottery game, upon confirming that the user has not yet played the preset destination lottery game that is not the selected lottery game, the controller causes the display device to display a game screen causing the user to play the destination lottery game.

4. An information processing device comprising:
a display device; and
a controller that causes the display device to display a game screen notifying a user that a preset destination lottery game should be played in a case where the user has not yet played the preset destination lottery game that is not a lottery game that the user has selected, via a terminal device, from among a plurality of types of lottery games.

5. An information processing device comprising:
a display device; and
a controller that causes the display device to display a game screen causing a user to play a preset destination lottery game in a case where the user has not yet played the preset destination lottery game that is not a lottery game that the user has selected, via a terminal device, from among a plurality of types of lottery games.

6. The information processing device according to claim 1, wherein
the destination lottery game is a lottery game that is advantageous to the user.

7. A non-transitory computer readable recording medium storing instructions for causing a computer to execute:
restricting a user from playing a lottery game that the user has selected, via a terminal device, from among a plurality of types of lottery games, in a case where the user has not yet played a preset destination lottery game that is not the selected lottery game.

8. A non-transitory computer readable recording medium storing instructions for causing a computer to execute:
causing a display device to display a game screen notifying a user that a preset destination lottery game should be played in a case where the user has not yet played the preset destination lottery game that is not a lottery game that the user has selected, via a terminal device, from among a plurality of types of lottery games.

9. A non-transitory computer readable recording medium storing instructions for causing a computer to execute:
causing a display device to display a game screen causing a user to play a preset destination lottery game in a case where the user has not yet played the preset destination lottery game that is not a lottery game that the user has selected, via a terminal device, from among a plurality of types of lottery games.
